(19) United States
(12) Patent Application Publication
(10) Pub. No.: US 2023/0398855 A1
(43) Pub. Date: Dec. 14, 2023

(54) A WHEEL ASSEMBLY FOR AN ELECTRIC VEHICLE

(71) Applicant: APPLIED ELECTRIC VEHICLES PTY LTD, Victoria (AU)

(72) Inventors: Julian BROADBENT, Victoria (AU); Nicholas FARMER, Queensland (AU); Matthew Campbell GREAVES, Queensland (AU)

(21) Appl. No.: 18/033,430

(22) PCT Filed: Oct. 21, 2021
(86) PCT No.: PCT/AU2021/051230

§ 371 Date: Apr. 24, 2023

(30) Foreign Application Priority Data
Oct. 23, 2020 (AU) 2020903851

(51) Int. Cl. B60K 7/00; F16D 55/40; F16D 65/18

(52) U.S. Cl. CPC B60K 7/0007; F16D 55/40; F16D 65/186; F16D 2121/12

(57) ABSTRACT

A wheel assembly for an electrical vehicle. The wheel assembly comprising a hub integral with an electrical motor, and a fluid actuated fail-safe brake fitted to the assembly with at least one braking surface for frictional engagement with the rotor of the electrical motor. The brake in its non-actuated state is engaged with the rotor, and when fluidally actuated the brake is released to allow rotation of the rotor. A solenoid valve having a normally open state is in fluid communication with the pressurised fluid used to fluidally actuate the brake, and the solenoid valve is a closed when electrically powered thereby allowing fluid actuation to release the brake. In the event of a loss of electrical power the solenoid valve will revert to the normally open state, so that the brake is non-actuated and applies a braking force to the rotor.

### FIELD

This invention relates to a wheel assembly for an electric vehicle. In particular, the invention is described with reference to a wheel assembly in an electrically powered road vehicle having a platform with a removable modular pod. More particularly an embodiment is directed to a wheel assembly for use in an autonomous or semi-autonomous vehicle.

### BACKGROUND

Implementation of electrically powered vehicles for widespread road transportation presents numerous opportunities and challenges in vehicle design and engineering, even more so when considering fully or semi-autonomous electric vehicles. One of the overriding opportunities is in exploiting potential efficiencies available to electrically powered vehicles. Some of the ways that electric road vehicles can be made to operate in a more efficient manner include: reducing overall vehicle weight; optimising efficiency of conversion from stored energy to vehicle movement (i.e. drivetrain efficiency); optimising vehicle body size and interior space available for a given platform, and providing motive devices that are robust and have a level of redundancy that allows them to operate over a wide range of operating environments.

Electric powered vehicles are now commonly provided with wheel assemblies having electric motors disposed therein. However, many of these electric powered vehicles are now using electric by-wire braking, where there are no mechanical components between the driver and brake unit as is normally provided in conventional vehicle hydraulic brake systems.

Electromechanical braking systems are inherently bulky and difficult to package with a direct drive wheel motor. Additionally, an electromechanical braking unit typically requires both power and a control system to function, and if either is lost then the brake cannot function.

For electrically powered autonomous vehicles to be widely accepted, they must be able to have significant range and payload capabilities for both passengers and delivery of goods. With increased range and payload, all the vehicle's motive devices, including the electric drive motors and braking system, must have a certain level of robustness and redundancy, and the ability to be readily maintained and serviced.

In consideration of the above, an embodiment of the present invention aims to provide a wheel assembly comprising a hub integral with an electrical motor, and a fluid actuated fail-safe brake fitted within the assembly suitable for use in an electrically powered vehicle. This wheel assembly seeks to ameliorate at least one of the disadvantages of the prior art.

### SUMMARY

In a first aspect the present invention consists of a wheel assembly for an electric vehicle, said wheel assembly comprising a hub integral with an electrical motor, and a fluid actuated fail-safe brake fitted to said assembly with at least one braking surface for frictional engagement with a rotor of said electrical motor, wherein said brake in its non-actuated state is engaged with said rotor, and when fluidally actuated said brake is released to allow rotation of said rotor, characterised in that a solenoid valve having a normally open state is in fluid communication with the pressurised fluid used to fluidally actuate said brake, and said solenoid valve is closed when electrically powered thereby allowing fluid actuation to release said brake, and in the event of a loss of electrical power said solenoid valve will revert to said normally open state, so that said brake is non-actuated and applies a braking force to said rotor.

Preferably said brake is a pneumatically actuated brake.

Preferably said pneumatically actuated brake includes two said braking surfaces.

Preferably said pneumatically actuated brake comprises two adjacent preloaded spring plates each of which carries a respective said braking surface near its periphery.

Preferably said pneumatically actuated brake comprises at least one pneumatically expandable means of expansion disposed between said spring plates at a location near said brake surfaces, said means of expansion in fluid communication with an air supply.

Preferably actuation of said pneumatically actuated brake results in pneumatic expansion of said means of expansion, thereby forcing said spring plates and their respective braking surfaces away from said rotor.

Preferably in one arrangement said means of expansion is an annular bellows having openings in fluid communication with said air supply.

Preferably each said braking surface is frusto-conical.

Preferably each said braking surface is a braking seat integral with said spring plate.

Preferably each said braking surface is a brake pad mounted on said spring plate.

Preferably each said spring plate is acted upon by a further means of bias.

Preferably a restrictor valve is disposed in line with said pressurised fluid, such that in event of a loss of electrical power and said solenoid valve reverts to said normally open state, said restrictor valve fluidally dampens non-actuation of said brake and the resultant braking force applied to said rotor.

Preferably in another arrangement said means of expansion is an annular tube in fluid communication with said air supply.

Preferably said means of expansion is annular in shape.

Preferably in one arrangement said solenoid valve is a solenoid operated pressure control valve.

Preferably in another arrangement said solenoid valve is a latching solenoid valve.

In a second aspect the present invention consists of a wheel for an electric vehicle, said wheel comprising an electric motor integrated within the hub of said wheel, and a pneumatic actuated fail-safe brake fitted to said wheel with at least two braking surfaces for frictional engagement with a rotor of said electrical motor, wherein said brake in its non-actuated state is engaged with said rotor, and when pneumatically actuated said brake is released to allow rotation of said rotor, characterised in that a solenoid valve having a normally open state is in fluid communication with pressurised air used to pneumatically actuate said brake, and said solenoid valve is closed when electrically powered thereby allowing pneumatic actuation to release said brake, and in the event of said solenoid valve being de-energised it will revert to said normally open state, so that said brake non-actuates and engages said rotor.

Preferably said brake comprises two adjacent preloaded spring plates, each of which carries a respective said braking surface near its periphery, and said pneumatically actuated brake comprises an pneumatically expandable means of expansion disposed between said spring plates at a location near said brake surfaces, said means of expansion in fluid communication with a pressurised air supply, and actuation of said pneumatically actuated brake results in pneumatic expansion of said means of expansion, thereby forcing said spring plates and their respective braking surfaces away from said rotor.

Preferably each said spring plate is acted upon by a further bias means.

Preferably a restrictor valve is disposed in line with said pressurised air, such that when said solenoid valve de-energises and reverts to said normally open state, said restrictor valve pneumatically dampens non-actuation of said brake as it engages said rotor.

Preferably said means of expansion is annular in shape.

Preferably in one arrangement said means of expansion is at least one annular bellows.

Preferably in another arrangement said means of expansion is an annular tube.

Preferably in one arrangement said solenoid valve is a solenoid operated pressure control valve.

Preferably in another arrangement said solenoid valve is a latching solenoid valve.

### BRIEF DESCRIPTION OF THE DRAWINGS

Further disclosure, objects, advantages and aspects of the present invention may be better understood by those skilled in the relevant art by reference to the following description of preferred embodiments taken in conjunction with the accompanying drawings, which are given by way of illustration only and thus not limitative of the present invention, and in which:

FIG. 1 is a perspective view of an embodiment of an electric road vehicle having a platform carrying a removable modular pod, the platform having a plurality of wheels in accordance with the present invention.

FIG. 2 is an upper perspective view of the platform of the vehicle shown in FIG. 1.

FIG. 3 is an enlarged cutaway of a wheel depicted in FIG. 1, showing internal integrated electric motor and pneumatically fail-safe brake unit.

FIG. 4 is an enlarged partial schematic of the brake stator of the fail-safe brake unit of the wheel shown in FIG. 1.

FIG. 5 in enlarged partial internal view of the interior of wheel of FIG. 1 showing internal integrated electric motor and pneumatically fail-safe brake unit.

FIG. 6 is a pneumatic circuit diagram for operation of two of the fail-safe brake units of FIG. 3 in an opposed pair of wheels.

FIG. 7 is a partial perspective of a second alternative embodiment of the brake stator of the fail-safe brake unit that could be used with the wheel of FIG. 3.

FIG. 8 is a partial perspective of a third alternative embodiment of a brake stator of the fail-safe brake unit that could be used with the wheel of FIG. 3.

FIG. 9 is a partial perspective of a fourth alternative embodiment of a brake stator of the fail-safe brake unit that could be used with the wheel of FIG. 3.

### DETAILED DESCRIPTION

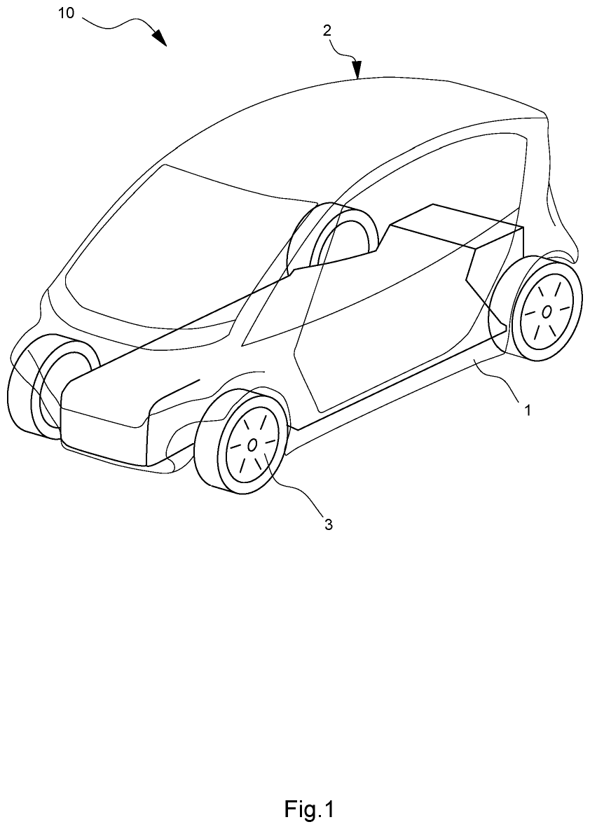

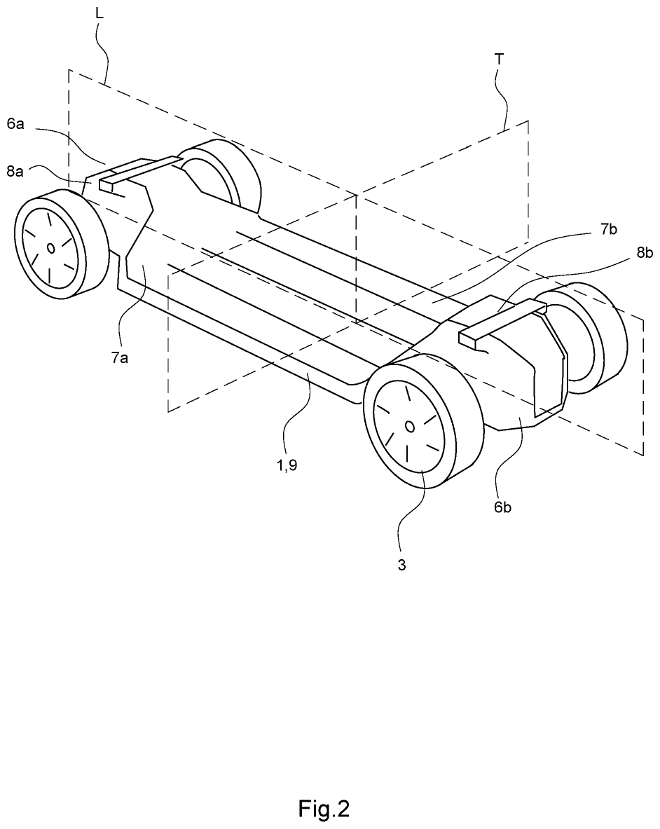

FIGS. 1 to 6 depict an embodiment of a modular self-contained wheel assembly 3, for use in a low-profile wheeled platform frame for an electrically powered road vehicle 10. Low profile wheeled platform frame 1, hereinafter referred to as a “platform”, forms part of a modular vehicle system, and road vehicle 10 is preferably an autonomous or semi-autonomous road vehicle.

Modular self-contained wheel assembly 3, will hereinafter be referred to as “wheel 3”.

Platform 1 substantially carries all the mechanical, electrical, and structural componentry necessary for fully functional road vehicle 10, including the drive and steering system, and the braking system.

Platform 1 carries a removable modular pod 2 which operably engages therewith. Modular pod 2 may be one of many variants to suit different commercial, industrial and passenger transportation applications. Regardless of which variant is used, each modular pod 2 has substantially the same “interface” for interchangeable connection to platform 1.

Platform 1 has a body made of a two piece (upper and lower) sealed enclosure. In this embodiment platform 1 is approximately 3.4 metres long, and about 1.48 metres wide and is about 0.75 metres high and capable of carrying a payload of about 1000 kg. Preferably platform 1 has a weight of less than 500 kg. Where modular pod 2 has a typical height of about 1.25 metres, and it is fitted to platform 1, the height of road vehicle 1 would be about 2 metres.

Platform 1 has four wheels (wheel assemblies) 3, namely two pairs of wheels. The first pair of wheels 3 are disposed on opposed sides of platform 1 near one end 6a thereof, and the second pair of wheels 3 are disposed on opposed sides of platform 1 near the other end 6b thereof. Each wheel 3 is driven by an independent electric motor 4 associated therewith.

Platform 1 is symmetric in shape and configuration, about its central longitudinal plane L lying on a longitudinal axis thereof, and its central transverse plane T lying on a transverse axis thereof, which is orthogonal thereto. As a result of this symmetric shape and configuration, opposed first and second ends 6a, 6b of platform 1 about transverse plane T appear the same, as do opposed first and second sides 7a, 7b about longitudinal plane L.

The body of platform 1, has raised cavity portions 8a, 8b near each of opposed first and second ends 6a, 6b respectively, interconnected by a lower slimmer central portion 9. Raised cavity portions 8a, 8b contain the wheel-drive and control componentry of platform 1, as well as the pod connection componentry that interconnects platform 1 to modular pod 2. Raised cavity portions 8a, 8b like that of ends 6a, 6b and sides 7a, 7b are similarly shaped to each other.

Preferably, platform 1 is bi-directional. When platform 1 is stationary, an external observer could not by simply looking at platform 1 discern (recognize) first and second ends 6a, 6b thereof as either fore and aft ends of platform 1. Rather first and second ends 6a and 6b of platform 1 may operably and indiscernibly by the shape and configuration of platform 1, interchange as the lead (fore) end of platform 1.

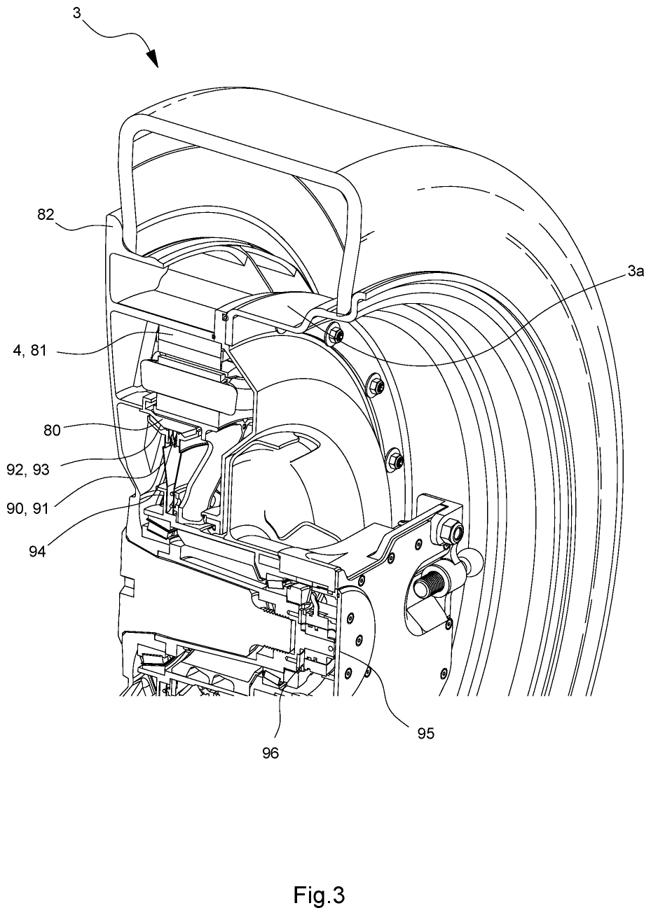

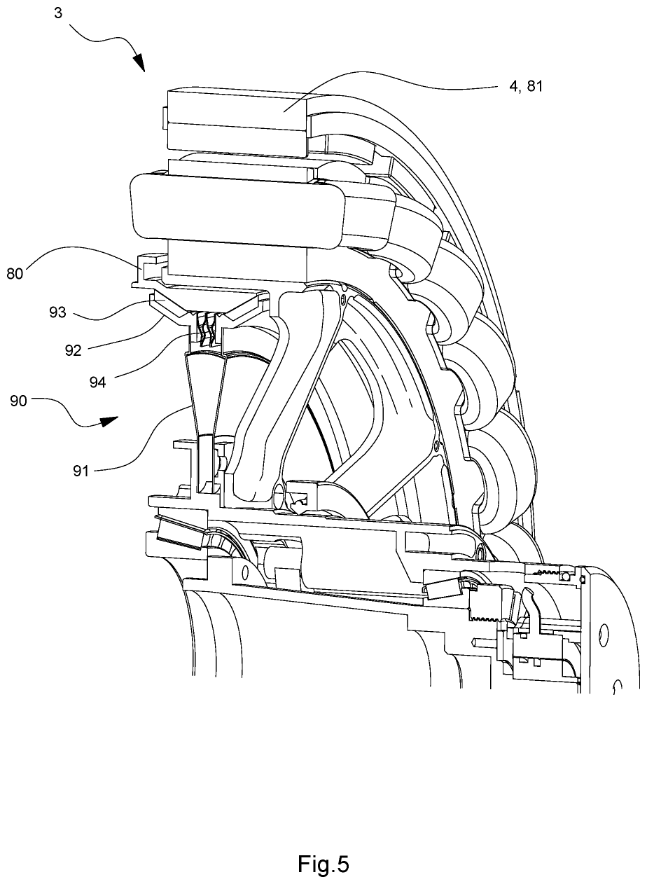

Each wheel 3, as shown in FIGS. 3 and 5 comprises an electric motor (and drive) 4 integrated into the wheel/rim structure. Unlike the prior art, where an electric motor is housed in a separate housing located in the hub, in this embodiment electric motor 4 is part of wheel hub 3a.

Electric motor 4 has a rotor backing iron 81 used to support the magnetic pole pieces of motor 4, attached to inside of rim 82.

Wheel 3 is also fitted with a self-actuating brake unit, namely a pneumatically actuated fail-safe brake unit 90, hereinafter referred to as “brake 90”.

Brake 90 comprises of two spring plates 91, each of which are preloaded during assembly to a near flat profile. In doing so, this puts a preload on brake 90. Each spring plate 91 has a brake pad seat 92 of frusto-conical form for carrying a brake pad 93. Spring plates 91 are preferably made of spring steel. Brake pad 93 is urged into engagement with brake rotor 80.

Whilst brake pad seats 92 might be used directly as a “braking surface”, it is preferable to have a non-metallic braking material added to it, in the form of brake pads 93 for improved performance. Where a brake pad of non-metallic braking material is used it may be less noisy, provide more efficient braking, and generate non-metallic dust.

A pneumatically actuated annular “bellows” structure 94, preferably of metal, allows brake pad seats 92 to open whilst maintaining an internally sealed volume.

Air is delivered to the inside of brake 90, namely the area between spring plates 91 via a solenoid 98. The solenoid valve 98 is configured to have a normally venting state and is mounted to or within suspension upright 95 with an incoming air path 97 and exhaust path from brake unit 90 through a restrictor valve/silencer 99 to atmosphere. Air path 97 is attached to suspension upright 95 and is internally routed to solenoid 98. An air supply tank 100, disposed on platform 1, receives air from air compressor 102, also on platform 1, and provides pressurized air to air path 97. A regulator (not shown) might be installed in air supply path 97 to regulate the pressure of air supply tank 100.

When electric power is supplied to solenoid valve 98, it closes the vent to atmosphere and connects air path 97 to brake 90, thereby allowing pneumatic actuation of bellows structure 94 to expand and urge spring plates 91 and brake pad seats 92 away from brake rotor 80. Thus, when solenoid valve 98 is powered, it releases the brake 90, and motive power is also supplied by motor 4. In the event of a loss of electrical power, solenoid valve 98 will revert to its normally venting state, so that brake 90 loses its pneumatic actuation (is non-actuated) and spring plates 91 apply a braking force to brake rotor 80. Additionally, a pressure sensor, force sensor or position sensor (not shown) might be integrated into the system to monitor the state of brake 90.

As such, brake (braking unit) 90 provides “fail-safe braking” as it will always be engaged, except for when electric power is delivered to solenoid valve 98 to allow its disengagement by pneumatic actuation.

A rotary position sensor 96 may also be preferably used for the position and speed of the wheel.

Each wheel 3, with its integral motor 4 and braking unit 90 is modular, and is easily installed and removed from platform 1, thus making for ease of installation and removal for replacement, service, and repair.

In platform 1, a pair of opposed wheels 3 are disposed on other side of a steering apparatus (not shown).

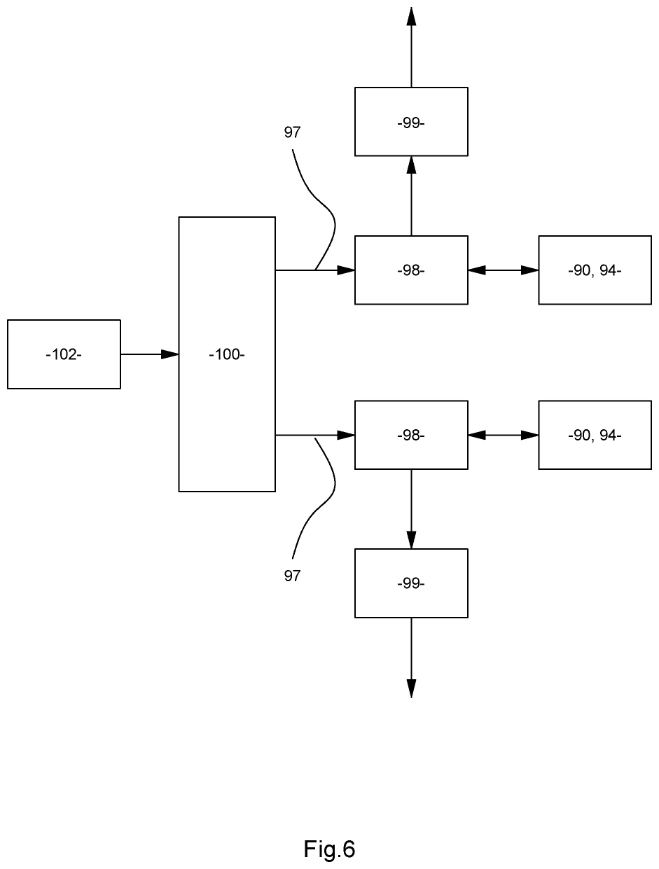

FIG. 6 depicts a schematic pneumatic circuit diagram for actuation of two brake units 90 for a pair of opposed wheels 3 of vehicle 10.

The operation of the braking function will now be described in more detail. Road vehicle 10 as an autonomous or semi-autonomous road vehicle, would typically be operating at speeds of less than 40 km/h. In use when road vehicle 10 is stationary or parked, each wheel 3 has its respective brake (fail-safe brake unit) 90 in its non-actuated state, so that spring plates 91 are biasing the braking surface, namely brake pads 93, into frictional engagement with brake rotor of electrical motor 4. In this non-actuated state, solenoid valve 98 associated with brake 90 is in its “normally open state”. When motive power is provided to each of electric motors 4 to propel vehicle 10, solenoid valve 98 is powered to close, thus allowing pressurised air from air supply tank 100 to pneumatically actuate bellows structure 94, which in turn releases brake pads 93 from brake rotor 80.

Where “powerful” electric motors 4 are used, these motors themselves will be used for both drive and braking during normal operation. However, brake 90 will typically be necessary for “extended hill hold” and as a park brake function. As such, in normal operation brake 90 would only need to function when wheel 3 is already stationary. This simplifies the “braking surface” requirements of brake pad 93, and thus inexpensive materials such as rubber or rubber-like materials are then possible for brake pads 93. As motors 4 are used for both drive and braking, an additional function of brake 90 is to provide emergency braking when there is a complete system failure of the electrical system. The possibility of such failure is extremely low, but the ability for brake 90 to be applied in this event is beneficial.

So, when road vehicle 10 is normally operated, drive and braking is achieved by control of electric motors 4. The primary purpose of brake 90 is firstly to engage and prevent movement of wheels 3 when vehicle 10 is stationary in certain situations or parked. Should there be a loss of power during operation of road vehicle 10, the fail-safe nature of brake 90 ensures solenoid valve 98 will open, so that the pneumatic actuation of bellows structure 94 ceases and spring plates 91 will bias brake pads 93 into engagement with brake rotor 80, thus preventing movement of wheel 3. Fluid restrictor valve 99 in the pneumatic circuit of airline 97, avoids rapid onset of braking.

Some of the advantages of the present embodiment of wheel assembly 3 are as follows:
it provides a compact electric motor/drive arrangement, as electric motor 4 is integral with the hub of wheel 3;
each brake 90 is integrated within wheel 3 and has non-complex components with minimal movement thereof;
since drive and braking functions are achieved via control of electric motors 4, the operation of brake 90 is only needed during certain stationary situations and parking, thus simplifying the “braking surface” requirements of brake pads 93; and
as wheel 3 is modular, it is relatively easy to replace along with the integrated electric motor 4 and brake 90.

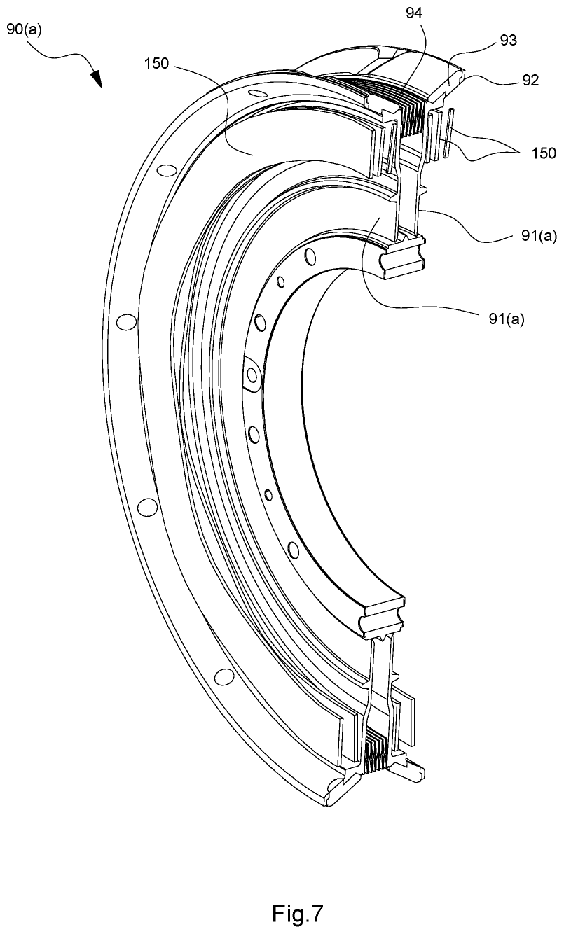

In the abovementioned embodiment spring plates 91 may rely solely on their own bias nature and preload to apply the “braking surface” to brake rotor 80. However, in an alternative second embodiment of a brake 90(a) as shown in FIG. 7, modified spring plates 91(a), smaller than the earlier described spring plates 91, and preferably of thicker material are used along with bellows 94. In this second embodiment, a further “means of bias” in the form of additional spring elements 150 may be used to act on each spring plate 91(a) to improve their bias nature.

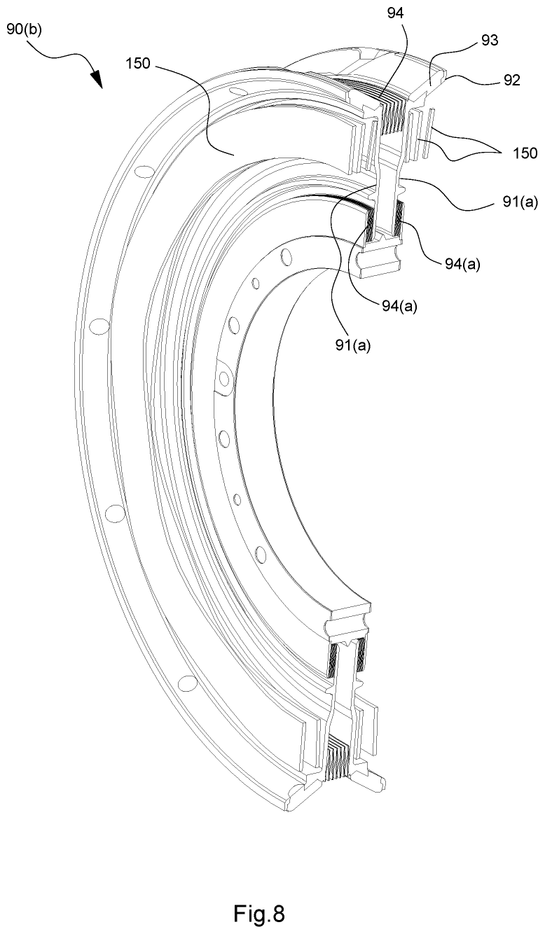

In a further alternative third embodiment of a brake 90(b) as shown in FIG. 8, a modified brake arrangement is shown using the same modified spring plates 91(a) and additional spring elements 150 and bellows 94 of the second embodiment of FIG. 7, to apply the “braking surface”, namely brake pads 93, to brake rotor 80. However, in this third embodiment, a pair of opposed bellows 94(a) are disposed at the end of the spring plates 91(a) furthest away from brake pads 93. These opposed bellows 94(a) are similar in structure and actuation to bellows 94. Like that of the second embodiment, additional spring elements 150 are used to act on spring plates 91(a) to improve their bias nature. However, to assist bellows 94, when pneumatically actuated, to act against the bias nature of spring plates 91(a) in combination with spring elements 150, the opposed pair of bellows 94(a) are also pneumatically actuated. The expansion of the pair of opposed bellows 94(a) by pneumatic actuation causes the portions of spring plates 91(a) adjacent to bellows 94(a) to be moved towards each other, thereby assisting the opening (splaying) at the other end, namely the portions of spring plates 91(a) adjacent bellows 94, to act against the bias force of spring plates 91(a) and spring elements 150.

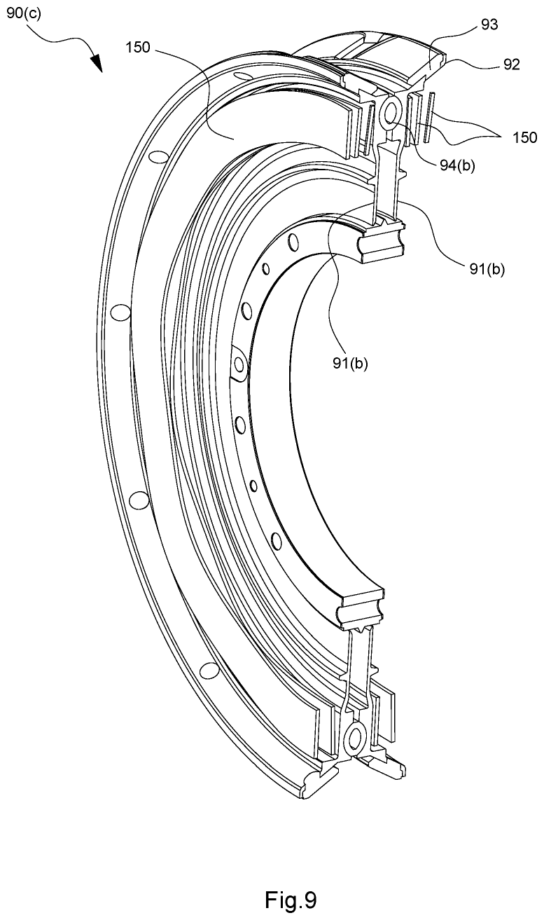

In a fourth alternative embodiment of a brake 90(c) as shown in FIG. 9, a modified brake arrangement is shown using modified spring plates 91(b) with additional spring elements 150 to apply the “braking surface”, namely brake pads 93, to brake rotor 80. In this arrangement rather than using a bellows as the “means of expansion”, an expandable annular tube 94(b) made of rubber or elastomer, also able to be expanded by pneumatic actuation, is employed. This annular tube 94(b), like that of the bellows of 94 and 94(a), is in fluid communication with air supply 100 via solenoid valve 98. In such arrangement spring plates 91(b) and spring elements 150 in combination provide the necessary bias force to keep the fail-safe brake engaged. However, when tube 94(b) is pneumatically actuated and expanded, it acts against the bias nature of the spring plates 91(b) and additional spring elements 150 to disengage the braking surface, namely brake pads 93 (seated on brake seats 92) away from rotor 80.

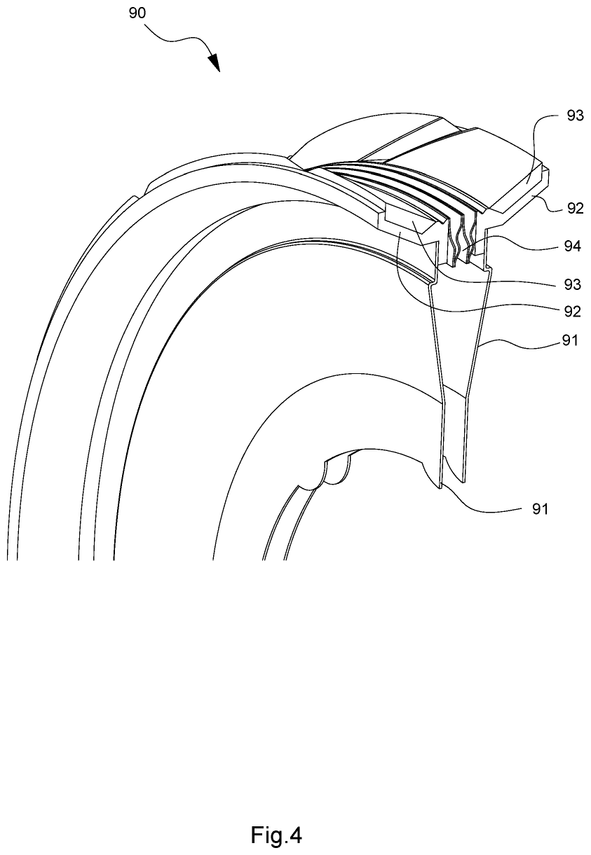

As such the various embodiments of brakes 90, 90(a), 90(b) and 90(c) shown respectively in FIGS. 4, 7, 8 and 9, depict how various “means of bias” may be employed to bias the braking surface, namely brake pads 93, into frictional engagement with brake rotor 80 of electrical motor 4, when solenoid valve 98 associated with the brake unit is in its “non-actuated” or “normally open state”. When motive power is provided to each of electric motors 4 to propel vehicle 10, solenoid valve 98 is powered to close, thus allowing pressurised air from air supply tank 100 to pneumatically actuate the “means of expansion”, which in turn releases brake pads 93 from brake rotor 80.

In the abovementioned embodiments spring plates 91, 91(a) and 91(b) require a sufficient “bias force” to normally engage brake pads 93 with brake rotor 80. To achieve this, spring plates 91, 91(a) and 91(b) may achieve this by various types of material, including but not limited to carbon steel, titanium, or spring steel, in combination with the shape and configuration of the spring plates. Furthermore, in the abovementioned alternative third and fourth embodiments depicted in FIG. 8 and FIG. 9 respectively, plates 91(a) and 91(b) may be substantially rigid in nature and essentially floating, with the “bias force” provided entirely by spring elements 150.

It is possible to select a degree of braking pressure in the embodiments shown in FIGS. 7, 8 and 9, by utilising spring elements 150 of various “bias force” type. For example, where road vehicle 10 is being used in applications at higher speeds, it may be preferable to use spring elements 150 providing a greater bias force, than would normally be used in low-speed applications. Spring elements 150 could readily be exchanged to suit the application and intended use of vehicle 10.

It should be understood solenoid valve 98, may be one of varying types. For example, in one alternative arrangement, solenoid valve 98 may be a solenoid operated pressure control valve which actively modulates the pressure of air within brake unit 90 to variably adjust the braking torque.

In a further alternative arrangement, solenoid valve 98 may be a latching solenoid valve, which requires a signal (pulse) to be supplied to alter the state of solenoid valve 98. This might be used in higher speed applications where unexpected application of the brakes is undesirable. In such arrangement the signal (pulse) would preferably be supplied to solenoid valve 98 when the wheel speed has decreased to a desired predetermined wheel speed. An alternative to the latching function of such a latching solenoid valve, might be achieved by replacing the passive restrictor valve 99 with an “active control valve”, which will not allow air to be released until a desired state is reached within the vehicle control system.

Restrictor valve 99 may in another arrangement be a relief valve for restricting and/or maintaining a back pressure on brake 90 to reduce braking force.

In the abovementioned embodiments, rotor 80 should preferably be able to axially slide (float) to some degree, so that axial forces are resolved internally within brake 90, and thereby minimize forces acting on its bearings.

In a not shown embodiment, electric motor 4, may be provided with a cable reel like surface that allows cables to follow a loop as it enters the structure of motor 4 to allow for steering of the wheels without excessive bending.

Whilst the abovementioned wheel 3 is described with use of an electric vehicle 10 having a platform 1 and modular pod 2, wheel 3 could be used on other not shown electric vehicles.

Preferably, the abovementioned embodiment of the present invention is designed such that the wheel assembly 3 and its incorporated brake unit 90 of vehicle 10, meets the functional safety ASIL D standard in accordance with ISO26262.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A wheel assembly for an electric vehicle, said wheel assembly comprising a hub integral with an electrical motor, and a fluid actuated fail-safe brake fitted to said assembly with at least one braking surface for frictional engagement with a rotor of said electrical motor, wherein said brake in its non-actuated state is engaged with said rotor, and when fluidally actuated said brake is released to allow rotation of said rotor, characterised in that a solenoid valve having a normally open state is in fluid communication with the pressurised fluid used to fluidally actuate said brake, and said solenoid valve is closed when electrically powered thereby allowing fluid actuation to release said brake, and in the event of a loss of electrical power said solenoid valve will revert to said normally open state, so that said brake is non-actuated and applies a braking force to said rotor.

2. A wheel assembly as claimed in claim 1, wherein said brake is a pneumatically actuated brake.

3. A wheel assembly as claimed in claim 2, wherein said pneumatically actuated brake includes two said braking surfaces.

4. A wheel assembly as claimed in claim 3, wherein said pneumatically actuated brake comprises two adjacent preloaded spring plates each of which carries a respective said braking surface near its periphery.

5. A wheel assembly as claimed in claim 4, wherein said pneumatically actuated brake comprises at least one pneumatically expandable means of expansion disposed between said spring plates at a location near said brake surfaces, said means of expansion in fluid communication with an air supply.

6. A wheel assembly as claimed in claim 5, wherein actuation of said pneumatically actuated brake results in pneumatic expansion of said means of expansion, thereby forcing said spring plates and their respective braking surfaces away from said rotor.

7. A wheel assembly as claimed in claim 6, wherein said means of expansion is an annular bellows having openings in fluid communication with said air supply.

8. A wheel assembly as claimed in claim 7, wherein each said braking surface is frusto-conical.

9. A wheel assembly as claimed in claim 4,
wherein each said braking surface is a braking seat integral with said spring plate.

10. A wheel assembly as claimed in claim 9, wherein each said braking surface is a brake pad mounted on said spring plate.

11. A wheel assembly as claimed in claim 4, wherein each said spring plate is acted upon by a further means of bias.

12. A wheel assembly as claimed in claim 1, wherein a restrictor valve is disposed in line with said pressurised fluid, such that in event of a loss of electrical power and said solenoid valve reverts to said normally open state, said restrictor valve fluidally dampens non-actuation of said brake and the resultant braking force applied to said rotor.

13. A wheel assembly as claimed in claim 6, wherein said means of expansion is an annular tube in fluid communication with said air supply.

14. A wheel assembly as claimed in claim 6, wherein said means of expansion is annular in shape.

15. A wheel assembly as claimed in claim 1, wherein said solenoid valve is a solenoid operated pressure control valve.

16. A wheel assembly as claimed in claim 1, wherein said solenoid valve is a latching solenoid valve.

17. A wheel for an electric vehicle, said wheel comprising an electric motor integrated within the hub of said wheel, and a pneumatic actuated fail-safe brake fitted to said wheel with at least two braking surfaces for frictional engagement with a rotor of said electrical motor, wherein said brake in its non-actuated state is engaged with said rotor, and when pneumatically actuated said brake is released to allow rotation of said rotor, characterised in that a solenoid valve having a normally open state is in fluid communication with pressurised air used to pneumatically actuate said brake, and said solenoid valve is closed when electrically powered thereby allowing pneumatic actuation to release said brake, and in the event of said solenoid valve being de-energised it will revert to said normally open state, so that said brake non-actuates and engages said rotor.

18. A wheel as claimed in claim 17, wherein said brake comprises two adjacent preloaded spring plates, each of which carries a respective said braking surface near its periphery, and said pneumatically actuated brake comprises an pneumatically expandable means of expansion disposed between said spring plates at a location near said brake surfaces, said means of expansion in fluid communication with a pressurised air supply, and actuation of said pneumatically actuated brake results in pneumatic expansion of said means of expansion, thereby forcing said spring plates and their respective braking surfaces away from said rotor.

19. A wheel as claimed in claim 18, wherein each said spring plate is acted upon by a further bias means.

20. A wheel as claimed in claim 17, wherein a restrictor valve is disposed in line with said pressurised air, such that when said solenoid valve de-energises and reverts to said normally open state, said restrictor valve pneumatically dampens non-actuation of said brake as it engages said rotor.

21. (canceled)

22. (canceled)

23. (canceled)

24. (canceled)

25. (canceled)
